(19) United States
(12) Patent Application Publication
(10) Pub. No.: US 2007/0036973 A1
(43) Pub. Date: Feb. 15, 2007

(54) Composition for treating glass fibers and treated glass fibers

(76) Inventors: Eric L. Bruner, San Diego, CA (US); Eric L. Hanson, San Diego, CA (US); Gerald W. Gruber, Englewood, FL (US)

Correspondence Address: William J. Uhl, 4110 Devonwood Court, Murrysville, PA, 15668, US

(21) Appl. No.: 11/500,189

(22) Filed: Aug. 7, 2006

Related U.S. Application Data
(60) Provisional application No. 60/707,324, filed on Aug. 11, 2005.

(51) Int. Cl. B05D 5/06; C04B 9/02

(52) U.S. Cl. 428/364; 427/163.2; 106/14.12

(57) ABSTRACT

Compositions for treating glass fibers in which the composition comprises an organophosphorus acid or a derivative thereof are disclosed. Energy is applied to the glass fibers to bond the organophosphorus acid or derivative to the glass fibers.

### CROSS REFERENCE TO RELATED APPLICATION

The present application claims priority from U.S. Provisional Patent Application Ser. No. 60/707,324, filed Aug. 11, 2005.

### TECHNICAL FIELD

The present invention relates to treated glass fibers and to compositions for treating glass fibers.

### BACKGROUND OF THE INVENTION

In the manufacture of glass fiber reinforced composites, many of the properties of the composites are directly attributable to the bond between the glass fibers and the matrix material of the composite. To promote bond strength, a composition called a sizing composition is applied to the glass fibers. This composition comprises a film-forming polymer that binds strands of the glass fibers together and a coupling agent to chemically bond the glass fibers to the surrounding matrix material.

The coupling agent most often used is an organosilane such as glycidoxy-propyltrimethoxysilane. However, silanes hydrolyze with the moisture in the air and with any water present in the sizing composition. Consequently, more silane is used than that required in the absence of hydrolysis. Additionally, the sizing compositions containing silane are not stable since the hydrolysis of the silane yields higher molecular weight products that are undesirable.

U.S. Pat. No. 5,736,246 discloses sizing compositions for glass fibers containing silane coupling agents. The compositions are disclosed as being useful in corrosive environments such as an alkaline environment associated with cement. When the sized glass fibers are used to reinforce cement, it is preferred that a phosphonic acid or a phosphonic acid derivative be present in the composition. However, such compositions are not disclosed as being useful in the absence of silane coupling agents.

### SUMMARY OF THE INVENTION

The present invention relates to a composition for treating glass fibers. The composition comprises an organophosphorus acid or a derivative thereof to improve in the absence of silane the properties of a composite containing the treated glass fibers.

The invention also provides for the glass fiber coated with the composition as described above; to a glass fiber in which the organophosphorus acid or derivative thereof is bonded to the glass fiber; to a composite material comprising an organic or inorganic matrix reinforced with the glass fibers described above.

The invention also provides for a method of treating one or more glass fibers comprising the steps of:
(1) applying the composition described above to one or more glass fiber(s) to form coated glass fibers,
(2) supplying energy to the treated glass fiber(s) sufficient so as to bond the organophosphorus acid or derivative thereof to the glass fiber(s).

### DETAILED DESCRIPTION

The compositions of the present invention are for treating glass fibers that can be used to form composites in which a matrix material is reinforced with the treated glass fibers. The compositions improve the properties of the composite, for example, mechanical properties such as flexural strength and tensile strength. The treated glass fibers of the present invention can be used for any reinforcement application such as to reinforce organic matrix materials such as polyepoxide, unsaturated polyesters, rubber, phenolics or other organic materials. The matrix can also be an inorganic material such as cement, concrete, mortar and gypsum. The glass fiber treated with the compositions of the present invention can be of any conventional form, for example, chopped or continuous strand, roving, woven glass fiber strand and the like.

The glass fibers can be prepared and treated with the composition by any conventional method suitable for producing such fibers. For example, suitable fibers can be formed by attenuating molten glass into filaments through orifices in a bushing and the fibers coated with the composition by spraying or roll coating as is well known in the fiber-making art. The compositions may also be applied to preformed fibers, that is, fibers that were previously formed offline. Treatment or application can be by coating, such as immersion, spraying or roll coating.

After the glass fibers have been treated, energy is applied to the treated fibers sufficient to dry the composition and to bond the organophosphorus acid or derivative to the surface of the glass fiber. Heating can be by thermal means, by light, infrared radiation and/or microwave radiation. The coated glass fiber may then be combined with the matrix to form the composite article as is well known in the art.

Although, not intending to be bound by any theory, it is believed the organophosphorus acid or derivative thereof is adsorbed on the glass fibers. At the interface thereof, the acid groups or derivatives thereof are in proximity to the oxide and/or hydroxyl groups on the surface of the glass fibers. Supplying energy to the treated glass fibers brings about a chemical bonding in which acid groups or their derivatives react with the surface oxide and/or hydroxyl groups to form a phosphorus-oxygen-silicon bond. Typically the energy can be heat energy that will raise the temperature at the interface to 50-200° C., preferably 100-150° C. The heat energy is usually applied for at least 5 seconds, typically 5 seconds to 3 hours; although times of 30 to 60 seconds are more typical. Also, energy can be infrared energy that is effective at ambient temperature.

For many applications, the compositions of the present invention typically comprise the organophosphorus acid or derivative thereof together with a diluent and optionally a film-forming polymer.

The diluents can be organic solvent(s), water or mixtures of organic solvent and water. Preferably, the diluent is water or a mixture of water and minor amounts of organic solvents. Typically, the diluent will be 90 to 100 percent by weight water and 0 to 10 percent by weight organic solvent based on total diluent weight. Generally, the compositions contain a non-volatile content of at least 0.00001, typically 0.00001 to 30, and preferably 0.1 to 5 percent by weight with the remainder being diluent. Preferably, the compositions are aqueous-based with the various ingredients being dissolved, emulsified or suspended in the aqueous medium. The compositions according to the invention can be obtained by mixing all of the components at the same time or by adding the components in several steps. After mixing the various components, the diluent may be added to the mixture to obtain the desired composition.

When present, film-forming polymer is typically present in amounts of about 1 to 80 percent by weight based on non-volatile content of the composition. Suitable film-forming polymers include epoxy resins, vinyl ester resins, polyester resins, vinyl acetate polymers and copolymers, polyurethane polymers and acrylic polymers. Specific examples include low molecular weight epoxy resins. Typically such resins have an epoxy equivalent weight of from about 175 to about 275, more preferably from about 230 to about 250. The film-forming polymer is typically present in amounts of 40 to 80, preferably 50 to 75 percent by weight, based on the non-volatile content of the composition.

Examples of organophosphorus acids or derivatives thereof are organophosphoric acids, organophosphonic acids and/or organophosphinic acids including derivatives thereof. Examples of derivatives are materials that perform similarly as the acid precursors such as acid salts, acid esters and acid complexes. The organo group of the phosphorus acid may be a monomeric, oligomeric or polymeric group. Examples of monomeric phosphorus acids are phosphoric acids, phosphonic acids and phosphinic acids including derivatives thereof.

Examples of monomeric phosphoric acids are compounds or a mixture of compounds having the following structure:
(RO)ₓP(O)(OR′)
wherein x is 1-2, y is 1-2 and x+y=3, R is a radical having a total of 1-30, preferably 6-18 carbons, where R′ is H, a metal such as an alkali metal, for example, sodium or potassium, or lower alkyl having 1 to 4 carbons, such as methyl or ethyl. Preferably, a portion of R′ is H. The organic component of the phosphoric acid (R) can be aliphatic (e.g., alkyl having 2-20, preferably 6-18 carbon atoms) including an unsaturated carbon chain (e.g., an olefin), or can be aryl or aryl-substituted moiety.

Example of monomeric phosphonic acids are compounds or mixture of compounds having the formula: 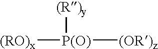
wherein x is 0-1, y is 1, z is 1-2 and x+y+z is 3. R and R″ are each independently a radical having a total of 1-30, preferably 6-18 carbons. R′ is H, a metal, such as an alkali metal, for example, sodium or potassium or lower alkyl having 1-4 carbons such as methyl or ethyl. Preferably at least a portion of R′ is H. The organic component of the phosphonic acid (R and R″) can be aliphatic (e.g., alkyl having 2-20, preferably 6-18 carbon atoms) including an unsaturated carbon chain (e.g., an olefin), or can be an aryl or aryl-substituted moiety.

Examples of monomeric phosphinic acids are compounds or mixtures of compounds having the formula: 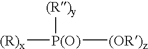
wherein x is 0-2, y is 0-2, z is 1 and x+y+z is 3. R and R″ are each independently radicals having a total of 1-30, preferably 6-18 carbons. R′ is H, a metal, such as an alkali metal, for example, sodium or potassium or lower alkyl having 1-4 carbons, such as methyl or ethyl. Preferably a portion of R′ is H. The organic component of the phosphinic acid (R, R″) can be aliphatic (e.g., alkyl having 2-20, preferably 6-18 carbon atoms) including an unsaturated carbon chain (e.g., an olefin), or can be an aryl or aryl-substituted moiety.

Representative of the organophosphorus acids are as follows: amino trismethylene phosphonic acid, aminobenzylphosphonic acid, 3-amino propyl phosphonic acid, O-aminophenyl phosphonic acid, 4-methoxyphenyl phosphonic acid, 4-hydroxyphenyl phosphonic acid, 4-hydroxybutyl phosphonic acid, aminophenylphosphonic acid, aminophosphonobutyric acid, aminopropylphosphonic acid, benzhydrylphosphonic acid, benzylphosphonic acid, butylphosphonic acid, carboxyethylphosphonic acid, diphenylphosphinic acid, dodecylphosphonic acid, 11-hydroxyundecyl phosphonic acid, ethylidenediphosphonic acid, heptadecylphosphonic acid, methylbenzylphosphonic acid, naphthylmethylphosphonic acid, octadecylphosphonic acid, octylphosphonic acid, pentylphosphonic acid, phenylphosphinic acid, phenylphosphonic acid, bis-(perfluoroheptyl) phosphinic acid, perfluorohexyl phosphonic acid, styrene phosphonic acid, dodecyl bis-1,12-phosphonic acid.

In addition to the monomeric phosphonic acid, oligomeric or polymeric phosphonic acids through self-condensation may be used.

The organophosphorus acids are present in the composition in amounts of at least 0.01 micro molar, usually from 0.01 micro molar to 30 milli molar. When the concentration of the organophosphorus compound in solution is dilute enough, that is below the critical micelle concentration (“CMC”). A monolayer of the organophosphorus moiety is believed to be formed on the surface of the fiber glass. The term “critical micelle concentration” is discussed by Kozo Shinoda in Solvent Properties of Surfactant Solutions, (1967), Marcel Dekker, Inc. N.Y., in Part 2 thereof, chapter 3, “Solvent Properties of Nonionic Surfactants in Aqueous Solutions”, beginning on page 42. The CMC for a species in solution refers to the concentration level at which the dissolved species is sufficient to form micelle structures. Accordingly, at concentrations lower than the CMC, the dissolved species exists as a monomolecular species that is surrounded by a solvent “shell”, and, at concentrations above the CMC, the dissolved species aggregate into micelle “domains” within the solution. As observed by Neves et al., discussed above, contact of surfaces with solutions containing aggregated structures, that is, micelles and bilayers, yields on surfaces contacted poly-layers of the dissolved materials. Accordingly, in the process of the invention utilizing a solution of an organophosphorus acid or a derivative thereof to provide an adsorbed mono-layer, it is preferred to employ a solution having an acid concentration below the critical micelle concentration.

In addition to the components mentioned above, the compositions of the invention can also include other components, such as lubricants, anti-static agents, emulsifiers, surface active agents, wetting agents, etc. Although the compositions do not require silane to improve the properties of a composite containing the glass fibers treated with the compositions, silane may be present in the composition. The proportion of these agents contained in the composition is preferably less than 30 percent by weight based on the non-volatile components of the composition.

The above description of the invention has been made to illustrate preferred features and embodiments of the invention. Other embodiments and modifications will be apparent to those skilled in the art through routine practice of the invention. Thus, the invention is intended not to be limited to the features and embodiments particularly described above, but to be defined by the appended claims and equivalents thereof.

What is claimed is:

1. A composition for treating glass fibers comprising an organophosphorus acid or a derivative thereof; the acid or derivative thereof being present in an amount sufficient to improve in the absence of silane the properties of a composite containing the treated glass fibers.

2. The composition of claim 1 in which the organo group of the phosphorus acid or derivative thereof is a monomeric, oligomeric or polymeric group.

3. The composition of claim 1 in which the organophosphorus acid or derivative thereof is an organophosphonic acid and/or an organophosphinic acid including derivatives thereof.

4. The composition of claim 1 in which the organophosphorus acid is an organophosphonic acid selected from 4-hydroxybutyl phosphonic acid and 4-hydroxyphenyl phosphonic acid.

5. The composition of claim 1 in which the organophosphorus acid is present in the composition in amounts of at least 0.01 micro molar.

6. The composition of claim 1, which contains a diluent.

7. The composition of claim 6 in which the diluent comprises water.

8. The composition of claim 1, which contains a film-forming polymer.

9. An aqueous composition for treating glass fibers comprising an organophosphorus acid dissolved or dispersed in an aqueous diluent and being present in the diluent in amounts of 0.01 micromolar to 30 millimolar to improve the properties of a composite containing the treated glass fiber.

10. A glass fiber treated with the composition of claim 1.

11. A glass fiber in which an organophosphorus acid or derivative thereof is bonded to the surface of the glass fiber.

12. A composite comprising an organic or an inorganic matrix reinforced with glass fibers of claim 10.

13. A method of treating a glass fiber comprising the steps of:
(1) applying the composition of claim 1 to one or more glass fibers to form coated glass fiber(s),
(2) supplying energy to the coated glass fiber(s) sufficient to bond the composition to the glass fiber(s).

14. The method of claim 13 in which the composition is applied by roll coating.
